(19) United States
(12) Patent Application Publication
(10) Pub. No.: US 2005/0125738 A1
(43) Pub. Date: Jun. 9, 2005

(54) Composite network-accesible services

(76) Inventors: Biplav Srivastava, Noida (IN); Mangala Gowri Nanda, New Delhi (IN); Neeran M. Karnik, New Delhi (IN)

Correspondence Address: Frederick W. Gibb, III;McGinn & Gibb, PLLC, Suite 304, 2568-A Riva Road, Annapolis, MD, 21401, US

(21) Appl. No.: 10/727,672

(22) Filed: Dec. 4, 2003

(51) Int. Cl. G06F 17/00

(52) U.S. Cl. 715/760

(57) ABSTRACT

Plan construction and selection decision phase is conducted separately from a plan assignment phase. Furthermore, the estimation of runtime variables is separated from the assignment of service instances. Moreover, at each stage, feedback is provided to enable the composition of the plan to be continuously refined. Optimization of runtime metrics can also be modelled for selection and composition of web services, or any other service-oriented architecture technology in which an application is described using a predetermined description language.

### FIELD OF THE INVENTION

The present invention relates to planning composite network-accessible services.

### BACKGROUND

Composite network-accessible services, such as Web services, are reusable software components that can be discovered and invoked by distributed applications to delegate their sub-functionality. The specification of a Web service is published to a directory, and is made available for online access by deploying the service on an application server. Applications search for Web services of interest from the Web services directory, and invoke appropriate candidates using the published access information.

A composite service can be created by defining a workflow that controls how data is routed through several simpler component services, as well as how the intermediate output data is processed (between Web service invocations). For creating such composite services, one can manually define the workflow using a standard language, stitching together existing web services. The composite service thus defined is published to the directory, thereby making the service available to applications, as well as to developers, to serve as a component of yet more complex services.

There are a number of languages to represent Web services composition. Examples include Planning Domain Description Language (PDDL), Business Process Execution Language for Web Services (BPEL4WS), and Web Services Flow Language (WSFL).

Users specify the plan or the workflow, and methods (called Web service orchestration methods) are available to locally optimize web services execution using data flow and control flow analysis. One suitable example is described by Gowri, Mangala and Karnik, Neeran (2003), in “Coordinating Components in Decentralized Composite Web Services”, Proceedings of the Association of Computing Machinery International. Symposium on Applied Computing, Melbourne (Fla.), March 2003.

In orchestration methods, selection of Web services is mostly manual—the developer lists the service instances that are substitutable. Some planning-based methods for automatic selection of services are available, which assume that service description is known completely. One such method is described by Srivastava, B. in “Automatic Web Services Composition Using Planning”, Proceedings of Knowledge Based Computer System (KBCS), Mumbai, pages 467 to 477, 2002, ISBN 81-259-1428-5.

While the techniques described above are in many ways satisfactory for their intended purpose, improvements can be made to the way in which network-accesible services are provided.

### SUMMARY

A plan construction and selection decision phase is conducted separately from a plan assignment phase. Furthermore, the estimation of runtime variables is separated from the assignment of service instances. Moreover, at each stage, feedback is provided to enable the composition of the plan to be continuously refined. Optimization of runtime metrics can also be modelled for selection and composition of web services, or any other service-oriented architecture (SOA) technology in which an application is described using a predetermined description language.

The abstract plan can be represented in the Planning Domain Description Language (PDDL) or any other suitable workflow language, such as PDDL, BPEL4WS, WSFL, or any other suitable services composition language. The instantiated plan can also be represented in the same manner as the abstract plan.

A plan selector performs a first phase of selecting an abstract plan that satisfies the logical goals of, for example, a web service. The output is an abstract plan that identifies the types of services to use, and in what order. A plan assigner then receives the abstract plan from the plan selector, and assigns specific instances of web services to the nodes in the abstract plan produced by the plan selector, thus producing an instantiated plan. This assignment can at first instance be predetermined or random. A runtime evaluator checks if the instantiated plan produced by the plan assigner violates any runtime constraints, such as constraints relating to response time, throughput, cost, and so on.

The instantiated plan can be executed if no constraints are violated. Otherwise, feedback is provided to enable the composition of the plan to be refined. Feedback is used to arrive at an acceptable workflow based on actual runtime constraints, rather than using a random “trial-and-error” or “brute-force” search over the search space.

### DESCRIPTION OF DRAWINGS

FIG. 1 is a schematic representation of components of a system for composing services.

FIG. 2 is a schematic representations of components of first and second configurations for composing network services, presented in greater detail than in FIG. 1.

FIG. 3 is a schematic representation of an example of three different services that can be used by a web application.

FIG. 4 is a schematic representation of two alternative plans that may be used in the example presented in FIG. 3.

FIG. 5 is a schematic representation of a computer system suitable for composing network services.

### DETAILED DESCRIPTION

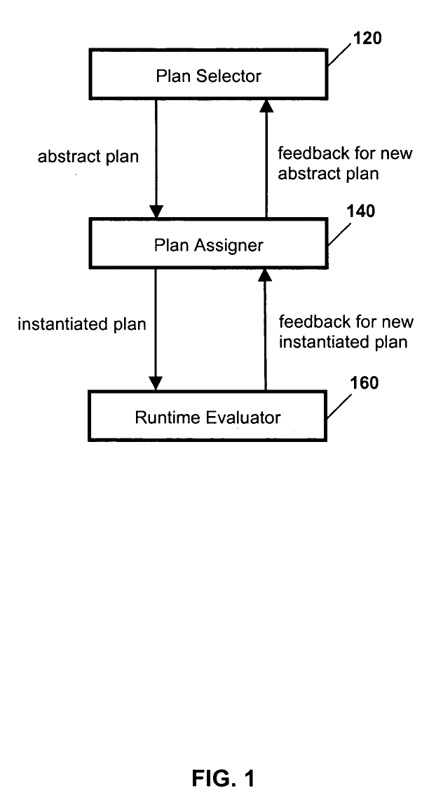

FIG. 1 schematically represents components used for composing composite services. These components are a Plan Selector 110, which interacts with a Plan Assigner 140, which in turn interacts with a Runtime Evaluator 160.

A workflow plan is a representation of the composed Web service, and can be specified using any suitable workflow language. A workflow language can be, for example, a Web services composition language. A workflow plan is created automatically based on the goals of the composite service and is executed/managed automatically.

The workflow plan can be created as follows. Artificial Intelligence (AI) planning is a discipline of computer science that has developed techniques to synthesize plans based on description of a formal domain theory and the set goal. Further and more detailed information about planning considerations is available in a publication by Daniel S. Weld, entitled “Recent Advances in AI Planning”, AI Magazine, Volume 20, No. 2, 1999, pp 93-123.

First, some preliminary observations are made concerning the theoretical basis of composite services. An object is an entity represented by terms (constants or variables) in a domain. A predicate is a logical construct that refers to the relationship between objects in the domain. A state T is simply a collection of facts with the semantics that information corresponding to the predicates in the state holds (that is, is true). An action A_i is applicable in a state T if the precondition of A_i is satisfied in T and the resulting state T′ is obtained by incorporating the effects of A_i. An action sequence S (a plan) is a solution to P if S can be executed from I and the resulting state of the world contains G.

A planning problem P is a 3-tuple <I, G, A>, in which I is the complete description of the initial state, G is the partial description of the goal state, and A is the set of executable (primitive) actions. To create plans for composing Web services, Web services are modelled as actions. Thus, information about a Web service component, including its preconditions (dependencies or inputs) and effects (functionalities or outputs), is represented by predicates. Now given a specification (or objective) of the aggregate service, a planning problem is formulated and solved using existing algorithms.

State-space planners are a type of planning algorithm that searches the space of possible plans (that is, sequences of actions). Table 1 below presents a pseudo-code template of a standard state-space planning algorithm that can reason with information of components (actions) represented as predicates. The software component FindSequence can accept problems in which information is represented as predicates. FindSequence is used as a base planner to illustrate one particular example. Other types of planners, such as plan-space planners (that is, planners which reason in the space of world (information) states) can also be used.

```
TABLE 1
FindSequence(I, G, A)
  1. If I ⊃ G
  2. Return {}
  3. End-if
  4. Ninit.sequence = {}; Ninit.state = I
  5. Q = {Ninit}
  6. While Q is not empty
  7. N = Remove an element from Q (heuristic choice)
  8. Let S = N.sequence; T = N.state
  9. For each component Ai in A
  10. If precondition of Ai is satisfied in state S
  11. Create new node N′ with:
                      N′.state = Update S with result of
    effect of Ai and
                      N′.sequence = Append(N.sequence, A_I)
  12. End-if
  13. If N′.state ⊃ G
  14. Return N′ ;; Return a plan
  15. End-if
  16. Q = Q U N′
  17. End-for
  18.End-while
  19.Return FAIL ;; No plan was found
```

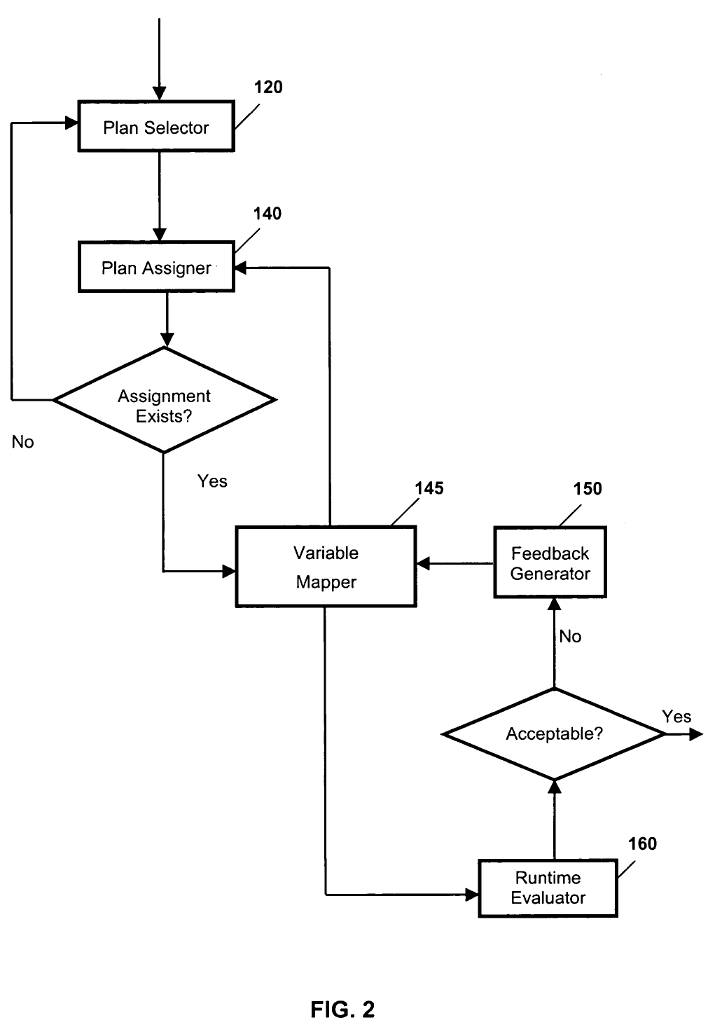

FIG. 2 presents the components of FIG. 1 in further detail. The Plan Selector 110 performs a first phase of selecting an abstract plan that satisfies the logical goals of, for example, a web service. The output of the Plan Selector 120 is an abstract plan that identifies the types of services to use, and in what order.

The Plan Assigner 140 receives the abstract plan from the Plan Selector 110, and assigns specific instances of web services to the nodes in the abstract plan produced by the Plan Selector 120, thus producing an instantiated plan. This assignment can at first instance be predetermined or random. Subsequent assignments are performed on the basis of information provided by the runtime engine concerning the feasible assignment choices.

Runtime Evaluator 160 checks if the instantiated plan produced by the Plan Assigner 140 violates any runtime constraints. As described in further detail below, such constraints can include response time, throughput, cost, availability, conflict of interest, and so on These constraints are usually defined in a Service Level Agreement (SLA) document, which is typically the basis for such restraints.

The instantiated plan can be executed if no constraints are violated. Feedback is provided to enable the composition of the plan to be refined. If the assignment is acceptable in the first instance, no feedback is provided. Otherwise, feedback is used to arrive at an acceptable workflow based on actual runtime conditions, rather than using a random “trial-and-error” or “brute-force” search over the search space.

Plan Selection

The Plan Selector 120 can search for plans that satisfy the logical goals for which web services are being composed. Existing Artificial Intelligence (AI) planning techniques can be used for this purpose. A suitable technique is described, by way of example, in Weld, D, 1999, Recent Advances in AI Planning, AI Magazine, volume 20, No.2, pages 93 to 123.

This and other planning techniques specifically take goal and state transition specifications (here, service type descriptions) as inputs and synthesize plans to achieve the goals. The output is an abstract plan (denoted as APi) that identifies the types of services to use, and in what order. No commitment is made as to the exact service instances.

Plan Evaluation

The output is an instantiated plan Pi, along with potential alternatives for the node choices. If any runtime constraint is violated, the Runtime Evaluator 160 can guide the Plan Assigner 140 with alternatives.

Constraint Satisfaction Problem (CSP) techniques can be used for assigning values to variables and for detecting constraint violations. A suitable example of such a technique is described in Kumar, V (1992). “Algorithms for Constraint-Satisfaction Problems: A Survey”. AI Magazine, Volume 13, pages 32-44, No.1. A copy of this reference is available at citeseer.nj.nec.com/kumar92algorithms.html.

The Plan Assigner 140 provides two pieces of information to the Runtime Evaluator 160. One is the list of Plan Assigner 140 variables and their currently feasible range. The other information is the mapping between the Plan Assigner 140 and Runtime Evaluator 160 variables.

Alternative Abstract Plans

When the Plan Assigner 140 can no longer make further assignments, which will happen when the range (set of possible values) of any of the Plan Assigner 140 variables is empty, the Plan Assigner 140 can ask the Plan Selector 120 to provide an alternative plan. It can also tell the Plan Selector 120 about the Plan Assigner 140 variable (that is, the node in the plan), which caused the problem so that the Plan Selector 120 module can “guide away” from this unsuccessful assignment failure. That is, potentially infeasible solutions are discounted to prevent the reported assignment failure. The top alternatives are more likely to be acceptable

An initial plan is created manually, but is managed automatically by feedback between the Runtime Evaluator 160 and the Plan Assigner 140, and the Plan Assigner 140 and the Plan Selector 120. The Plan Selector 120 is not used in creating the initial plan, but may be invoked to create alternative plans, if runtime constraints are violated.

Variable Mapping

The Variable Mapper 145 keeps track of the correspondence between the variables of the Plan Assigner 140 and the variables of the Runtime Evaluator 160 that are consequently affected. Variable Mapper 145 maps variables but does not specify the functional relationship between the two sets of variables.

Runtime Evaluator 160 receives an instantiated plan Pi, and calculates the value of the runtime variables. Runtime Evaluator 160 then checks if the plan violates the system runtime constraints. Instantiated plan Pi is acceptable as the composed service if there is no violations. Otherwise, the Runtime Evaluator 160 interacts with the Feedback Generator 150 to provide feedback to Plan Assigner 120.

Feedback

Feedback Generator 150 is involved with the instantiated plan Pi, if a violation is possible. The Feedback Generator 150 references the estimated value of the runtime variables the Feedback Generator 150 is monitoring, and prepares feedback for the Plan Assigner 140 concerning any infeasibility among the alternative values for each of the variables of the Plan Assigner 140. The Feedback Generator 150 is not expected to consider the value of alternative plans. Such considerations are specifically the role of the Plan Assigner 140. There is a division of labor between the Plan Selector 120 and the Plan Assigner 140. The Feedback Generator 150 works in tandem with the Plan Assigner 140 but does not give feedback to Plan Selector 120. The Plan Assignee 140 gives feedback to Plan Selector 120.

The feedback from the Runtime Evaluator 160 to the Plan Assigner 140 can be in terms of feasibility constraints involving Plan Assigner 140 variables 1, 2, . . . k, where k is the total number of Plan Assigner 140 variables in the plan.

### EXAMPLE

An example is presented using the runtime metric of service invocation cost that involves the estimation of individual service instances, and response time, which involves estimating delays between any two instances of services. Runtime metrics can be extended to up to k variables. Other metrics that can be mapped to some normalized function of the above runtime metrics can also be used.

The example application is required to find the driving directions between the locations of two people whose names are known. That is, given the names of two people, the application is required be able to give street-level instructions concerning how to drive from the location of the first person to the location of the second person. An application (or composite service) uses two persons' names and provides driving directions between their respective homes.

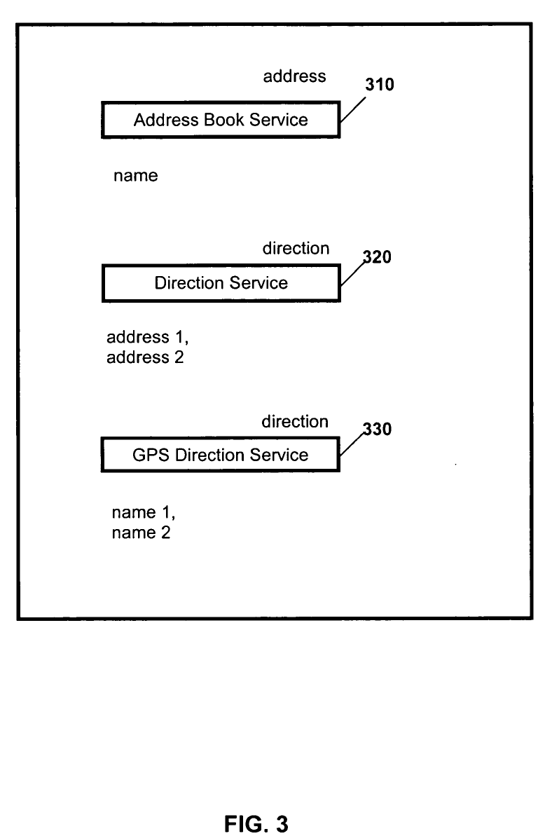

FIG. 3 schematically represents three types of web services relevant to the described example. There is an AddressBookService 310, which can return the address of a person given her name, a DirectionService 320, which can return the driving directions between two input addresses, and a GPSDirectionService 330, which can return the driving directions between the locations of two people given their names.

Table 2 below tabulates these services, with available service instances.

TABLE 2

| Service Type | Service Instances |
|---|---|
| AddressBookService | AD₁, AD₂, AD₃, AD₄ |
| DirectionService | DD₁, DD₂ |
| GPSDirectionService | GPS₁, GPS₂ |

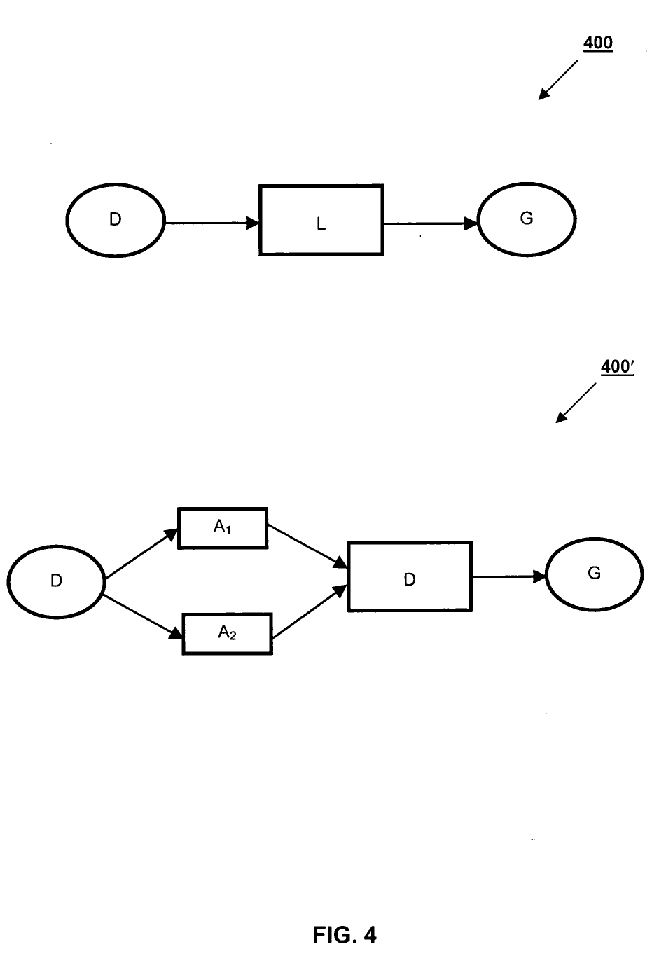

FIG. 4 schematically represents possible choices of the Plan Selector 120, as plan P1 400 and plan P2 400′. For plan P1 400, the choices for Plan Assigner 140 are L={GPS1, GPS2}. For plan P2 400′, the choices for Plan Assigner 140 are A1, A2={AD1, AD2, AD3, AD4} and D={DD1, DD2}.

The runtime variable of cost has possible values C={25, 50, 100, 200}. That is, the cost, in dollars, is one of 25, 50, 100, 200. A cost estimate C for each service is presented in Table 3 below.

TABLE 3

| | | |
|---|---|---|
| AD₁ | [symbol] | 25 |
| AD₂ | [symbol] | 25 |
| AD₃ | [symbol] | 25 |
| AD₄ | [symbol] | 50 |
| GPS₁ | [symbol] | 200 |
| GPS₂ | [symbol] | 200 |
| DD₁ | [symbol] | 25 |
| DD₂ | [symbol] | 50 |

The only constraint evident from Table 3 above is that the cost C is less than 100 units. The mapping is any service in an instantiated plan that can contribute to cost C. The Runtime Evaluator 160 estimates the cost of each of the service instances and maintains Table 3 above by updating service instances and their associated cost as required.

Table 4 below is a system trace that follows iterations of the plan.

TABLE 4
Iteration 1

| | |
|---|---|
| Plan Selector 120 output | P₁ |
| Plan Assigner 140 output | L = GPS₁ |

```
      Plan Assigner 140 variables and their feasible range
            Mapping: (L → C)
            Variable L contributes to C
```

| | |
|---|---|
| Runtime Evaluator 160 output | Analysis: C > 100 (Violation) |
| | Feedback: C < 100 |
| Plan Assigner 140 feedback | L has no feasible (lower) assignment |
| | Feedback: L = NIL |

Iteration 2

| | |
|---|---|
| Plan Selector 120 output | P₂ |
| Plan Assigner 140 output | A₁ = AD₁ |
| | A₂ = AD₄ |
| | D = DD₁ |
| | Plan Assigner 140 variables and their |
| | feasible range |
| | Mapping: (A₁, A₂, D → C) |
| | Variables A₁, A₂, D contribute to C |
| Runtime Evaluator 160 output | Analysis: C = 100 (Violation) |
| | Feedback: C < 100 |
| Plan Assigner 140 feedback | A₁ has no lower assignment |
| | A₂ has lower assignment |
| | D has no lower assignment |
| | thus |
| | No change in A₁, D possible |
| | A₂ has feasible alternatives |

Iteration 3

| | |
|---|---|
| Plan Selector 120 output | P₂ |
| Plan Assigner 140 output | A₁ = AD₁ |
| | A₂ = AD₂ |
| | D = DD₁ |
| | Plan Assigner 140 variables and their |
| | feasible range |
| | Mapping: (A₁, A₂, D → C) |
| | Variables A₁, A₂, D contribute to C |
| Runtime Evaluator 160 output | Analysis: C = 75 (No Violation) |

Optimization of Response Time Variable

Runtime variable: R={25, 50, 100, 200}. The response time, R, is one of 25, 50, 100, 200. Table 5 below tabulates response-time estimates for each pair of services subject to the constraints of a response time R being less than 40.

TABLE 5

| | | |
|---|---|---|
| AD₁-DD₁ | [symbol] | 50 |
| AD₂-DD₁ | [symbol] | 30 |
| AD₃-DD₁ | [symbol] | 25 |
| AD₄-DD₁ | [symbol] | 40 |
| AD₁-DD₂ | [symbol] | 60 |
| AD₂-DD₂ | [symbol] | 60 |
| AD₃-DD₂ | [symbol] | 60 |
| AD₄-DD₂ | [symbol] | 60 |
| GPS₁ | [symbol] | 100 |
| (roundtrip) | | |
| GPS₂ | [symbol] | 200 |
| (roundtrip) | | |

All services are mapped on any (critical) path in the plan can contribute to response time R. The response time of a workflow plan is the maximum of the minimum response time along any path in the plan. The corresponding path is called the critical path of the plan. Table 6 below is a system trace that follows iterations of the plan.

TABLE 6
Iteration 1

| | |
|---|---|
| Plan Selector 120 output | P₁ |
| Plan Assigner 140 output | L = GPS₁ |
| | Plan Assigner 140 variables and their |
| | feasible range |
| | Mapping: (L → R) |
| | Variable L contributes to R |
| Runtime Evaluator 160 output | Analysis: R = 100 (Violation) |
| | Feedback: R < 40; |
| Plan Assigner 140 feedback | L has no feasible (lower) assignment |
| | Feedback: L = NIL |

Iteration 2

| | |
|---|---|
| Plan Selector 120 output | P₂ |
| Plan Assigner 140 output | A₁ = AD₁ |
| | A₂ = AD₄ |
| | D = DD₁ |
| | Plan Assigner 140 variables and their |
| feasible range | |
| | Mapping: ((A₁, D) or (A₂, D) → R) |
| | Variables A1 and D or A2 and D |
| | contribute to R |
| Runtime Evaluator 160 | Analysis: R = 40 (Violation) |
| | Feedback: R < 40 |
| | With D = DD1, feasible assignments are: |
| | A₁ has for AD₂/AD₃ |
| | A₂ has for AD₂/AD₃ |
| Plan Assigner 140 feedback | No change in value for D, |
| | A1 has alternatives AD2 and AD3, |
| | same for A2 |

Iteration 3

| | |
|---|---|
| Plan Selector 120 output | P₂ |
| Plan Assigner 140 output | A₁ = AD₂ |
| | A₂ = AD₃ |
| | D = DD₁ |
| | Plan Assigner 140 variables and their |
| | feasible range |
| | Mapping: ((A₁, D) or (A₂, D) → R) |
| | Variables A1 and D or A2 and D |
| | contribute to R |
| Runtime Evaluator 160 | Analysis: R = 30 (No violation) |

Computer Software

Table 7 below presents a pseudocode algorithm that can be used in composing services as described. This algorithm can be implemented using a standard programming language such as the C or Java programming languages.

TABLE 7

| | |
|---|---|
| 1. | Let AP = Find an abstract plan using Plan Selector |
| 2. | If AP is empty |
| | a. FAIL (no workflow exists). |
| 3. | Assign services instances to each variable in AP and produce a |
| | concrete plan P. |
| 4. | If a complete assignment was not found (P is null) |
| | a. Goto Step 1 (Plan Selector) |
| 5. | Define mapping between plan variables and runtime variables |
| 6. | Sent to Runtime Evaluator |
| 7. | If P does not violate runtime constraints |
| | a. Execute P |
| | b. DONE |
| 8. | Else |
| | a. Generate feedback |
| | b. Goto Step 3 (Plan Assigner) |

Computer Hardware

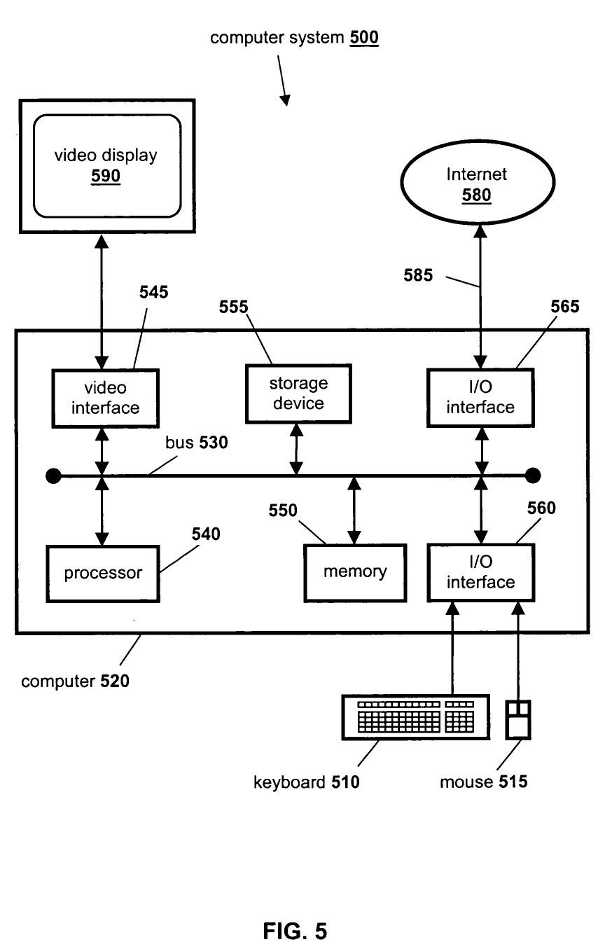

FIG. 5 is a schematic representation of a computer system 500 of a type suitable for composing services as described. Computer software executes under a suitable operating system installed on the computer system 500 to assist in performing the described techniques. This computer software is programmed using any suitable computer programming language, and may be thought of as comprising various software code means for achieving particular steps.

The components of the computer system 500 include a computer 520, a keyboard 510 and mouse 515, and a video display 590. The computer 520 includes a processor 540, a memory 550, input/output (I/O) interfaces 560, 565, a video interface 545, and a storage device 555.

The processor 540 is a central processing unit (CPU) that executes the operating system and the computer software executing under the operating system. The memory 550 includes random access memory (RAM) and read-only memory (ROM), and is used under direction of the processor 540.

The video interface 545 is connected to video display 590 and provides video signals for display on the video display 590. User input to operate the computer 520 is provided from the keyboard 510 and mouse 515. The storage device 555 can include a disk drive or any other suitable storage medium.

Each of the components of the computer 520 is connected to an internal bus 530 that includes data, address, and control buses, to allow components of the computer 520 to communicate with each other via the bus 530.

The computer system 500 can be connected to one or more other similar computers via a input/output (I/O) interface 565 using a communication channel 585 to a network, represented as the Internet 580.

The computer software may be recorded on a portable storage medium, in which case, the computer software program is accessed by the computer system 500 from the storage device 555. Alternatively, the computer software can be accessed directly from the Internet 580 by the computer 520. In either case, a user can interact with the computer system 500 using the keyboard 510 and mouse 515 to operate the programmed computer software executing on the computer 520.

Other configurations or types of computer systems can be equally well used to perform computational aspects of composing network services. The computer system 500 described above is described only as an example of a particular type of system suitable for implementing the described techniques.

Conclusion

Various alterations and modifications can be made to the techniques and arrangements described herein, as would be apparent to one skilled in the relevant art.

1. A method for composing network accessible services said method comprising the steps of:
storing an abstract plan that specifies a set of logical processes in a predetermined form;
determining an instantiated plan that specifies at least one particular service that can perform each one of the logical processes of the abstract plan; and
evaluating said instantiated plan for violations of predetermined constraints relating to execution of the instantiated plan.

2. The method as claimed in claim 1, further comprising the step of rejecting an instantiated plan if the evaluated instantiated plan violates at least one of the predetermined constraints.

3. The method as claimed in claim 1, further comprising the step of determining a set of parameters concerning the instantiated plan, and an approximate range of each of the parameters.

4. The method as claimed in claim 1, further comprising the step of composing an alternative abstract plan if the evaluated instantiated plan violates at least one of the predetermined constraints.

5. The method as claimed in claim 1, wherein the abstract plan specifies an ordered set of logical processes.

6. The method as claimed in claim 1, wherein the abstract plan is represented in a predetermined form using a web services composition language.

7. A computer program product for composing network accessible services comprising computer software recorded on a computer-readable medium for performing the steps of:
storing an abstract plan that specifies a set of logical processes in a predetermined form;
determining an instantiated plan that specifies at least one of particular service that can perform each one of the logical processes of the abstract plan; and
evaluating said instantiated plan for violations of predetermined constraints relating to execution of the instantiated plan.

8. A computer system for composing services comprising:
computer software code means for storing an abstract plan that specifies a set of logical processes in a predetermined form;
computer software code means for determining an instantiated plan that specifies at least one particular service that can perform each one of the logical processes of the abstract plan; and
computer software code means for evaluating said instantiated plan for violations of predetermined constraints relating to execution of the instantiated plan.

9. The computer program product in claim 7, further comprising the step of rejecting an instantiated plan if the evaluated instantiated plan violatcs at least one of the predetermined constraints.

10. The computer program product in claim 7, further comprising the step of determining a set of parameters concerning the instantiated plan, and an approximate range of each of the parameters.

11. The computer program product in claim 7, further comprising the step of composing an alternative abstract plan if the evaluated instantiated plan violates at least one of the predetermined constraints.

12. The computer program product in claim 7, wherein the abstract plan specifies an ordered set of logical processes.

13. The computer program product in claim 7, wherein the abstract plan is represented in a predetermined form using a web services composition language.
